(19) United States
(12) Patent Application Publication
(10) Pub. No.: US 2009/0134772 A1
(43) Pub. Date: May 28, 2009

(54) Color field emission display having carbon nanotubes

(75) Inventors: Yang Wei, Beijing (CN); Liang Liu, Beijing (CN); Shou-Shan Fan, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 12/069,300

(22) Filed: Feb. 8, 2008

(30) Foreign Application Priority Data
Nov. 23, 2007 (CN) 200710124774.5

(51) Int. Cl. H01J 1/62

(52) U.S. Cl. 313/495; 977/742

(57) ABSTRACT

A color field emission display includes a sealed container having a light permeable portion and at least one color element enclosed in the sealed container. The color element includes a cathode, at least two anodes, at least two phosphor layers and at least two CNT strings. The phosphor layers are formed on the end surfaces of the anode. The CNT strings are electrically connected to and in contact with the cathode with the emission portion thereof suspending. The phosphor layers are opposite to the light permeable portion, and one emission portion is corresponding to one phosphor layer. The luminance of the color FED is enhanced at a relatively low voltage.

### RELATED APPLICATIONS

This application is related to commonly-assigned, co-pending application: U.S. patent application Ser. No. ______, entitled “PIXEL TUBE FOR FIELD EMISSION DISPLAY”, filed ______ (Atty. Docket No. US16665) and U.S. patent application Ser. No. ______, entitled “COLOR FED FOR FIELD EMISSION DISPLAY”, filed ______ (Atty. Docket No. US16782). The disclosure of the respective above-identified application is incorporated herein by reference.

### BACKGROUND

1. Field of the Invention

The invention relates to color field emission displays and, particularly, to a color field emission display having carbon nanotubes.

2. Discussion of Related Art

Field emission displays (FEDs) are based on emission of electrons in vacuum. Electrons are emitted from micron-sized tips in a strong electric field, and the electrons are accelerated and collide with a fluorescent material, and then the fluorescent material emits visible light. FEDs are thin, light weight, and provide high levels of brightness.

Carbon nanotubes (CNTs) produced by means of arc discharge between graphite rods were first discovered and reported in an article by Sumio Iijima, entitled “Helical Microtubules of Graphitic Carbon” (Nature, Vol. 354, Nov. 7, 1991, pp. 56-58). CNTs also feature extremely high electrical conductivity, very small diameters (much less than 100 nanometers), large aspect ratios (i.e. length/diameter ratios) (greater than 1000), and a tip-surface area near the theoretical limit (the smaller the tip-surface area, the more concentrated the electric field, and the greater the field enhancement factor). These features tend to make CNTs ideal candidates for electron emitter in FED. Generally, a color FED of the FED includes a number of CNTs acting as electron emitters. However, single CNT is so tiny in size and then the controllability of the method manufacturing is less than desired. Further, the luminous efficiency of the FED is low due to the shield effect caused by the adjacent CNTs.

What is needed, therefore, is a color FED, which has high luminous efficiency and can be easily manufactured.

### SUMMARY

A color field emission display includes a sealed container having a light permeable portion and at least one color element enclosed in the sealed container. The color element includes a cathode, at least two anodes, at least two phosphor layers and at least two CNT strings. The phosphor layers are formed on the end surfaces of the anode. The CNT strings are electrically connected to and in contact with the cathode with the emission portion thereof suspending. The phosphor layers are opposite to the light permeable portion, and one emission portion is corresponding to one phosphor layer. In each CNT string, some of CNT bundles are taller than and project over the adjacent CNT bundles, and each of projecting CNT bundles functions as an electron emitter.

Compared with the conventional color FED, the present color FED has the following advantages: using CNT string as the electron emitter, and thus the color FED is more easily fabricated. Further, the emission portion of the CNT string is in a tooth-shape structure, which can prevent from the shield effect caused by the adjacent CNT bundles, and the turn-on voltage of the color FED is reduced.

Other advantages and novel features of the present color FED will become more apparent from the following detailed description of preferred embodiments when taken in conjunction with the accompanying drawings.

### BRIEF DESCRIPTION OF THE DRAWINGS

Many aspects of the present color FED can be better understood with reference to the following drawings. The components in the drawings are not necessarily to scale, the emphasis instead being placed upon clearly illustrating the principles of the present color FED.

FIG. 1 is a schematic, top-sectional view of a color FED according to an embodiment.

FIG. 2 is a schematic, cross-sectional view of a color FED according to an embodiment.

FIG. 3 is a schematic, amplificatory view of part 210 in FIG. 2.

FIG. 4 is a Scanning Electron Microscope (SEM) image, showing part 210 in FIG. 2.

FIG. 5 is a Transmission Electron Microscope (TEM) image, showing part 210 in FIG. 2.

Corresponding reference characters indicate corresponding parts throughout the several views. The exemplifications set out herein illustrate at least one preferred embodiment of the color FED, in one form, and such exemplifications are not to be construed as limiting the scope of the invention in any manner.

### DETAILED DESCRIPTION OF PREFERRED EMBODIMENTS

Reference will now be made to the drawings to describe the preferred embodiments of the present color FED having carbon nanotubes, in detail.

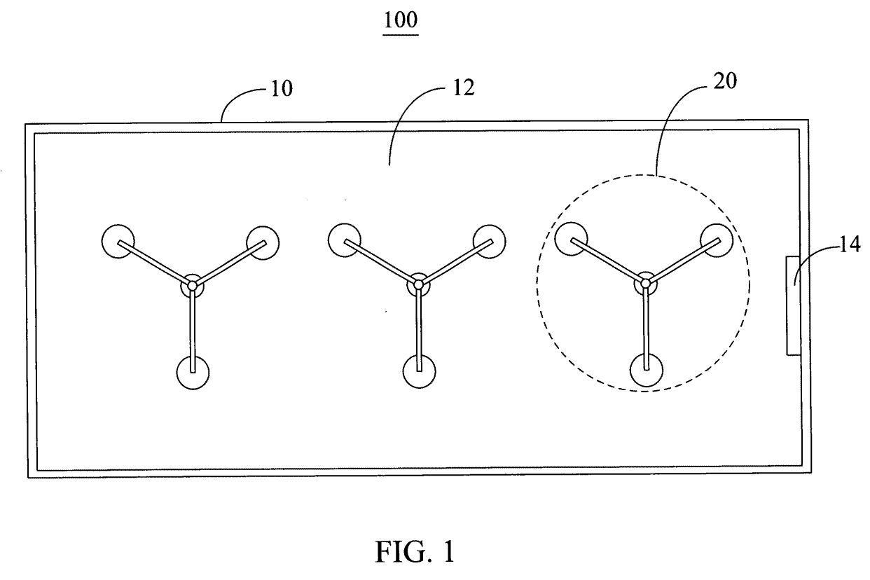

Referring to FIG. 1, a color FED 100 includes a sealed container 10 having a light permeable portion 12, and at least one color element 20 enclosed in the sealed container 10. The sealed container 10 is a hollow member that defines an inner space in vacuum. The cross section of the sealed container 10 has a shape selected from a group consisting of circular, ellipsoid, quadrangular, triangular, polygonal and so on. The sealed container 10 may be comprised of any nonmetallic material, and the emission portion 12 need be made of a transparent material. In the present embodiment, the sealed container 10 is a hollow cylinder and comprised of quartz or glass. A diameter of the sealed container 10 is about 2-10 millimeters (mm), and a height thereof is about 5-50 mm. The light permeable portion 12 has a surface selected from the group consisting of a plane surface, a spherical surface and an aspherical surface. Due to at least one color element 20 being sealed into one sealed container 10, the method for manufacturing the color FED 10 is simple and convenient, and the luminescence efficiency thereof is improved.

Each color element 20 includes a cathode, three anodes, three phosphor layers and three CNT strings. The distances between the cathode and the anodes are substantially equal, and are about 0.1-10 millimeters (mm). The spaces among the adjacent anodes are beneficially equal. The cathode is electrically connected to the cathode terminal, and the anodes are respectively electrically connected to the corresponding anode terminals. The cathode terminal, and the anode terminals run from the inside to the outside of the sealed container 10, and are supplied with the power source. By adjusting the voltages applied to the anode terminals, the color FED 100 can emit any kinds of color light beam, such as white, yellow. The cathode, the anodes, the cathode terminal and the anode terminals are made of thermally and electrically conductive materials.

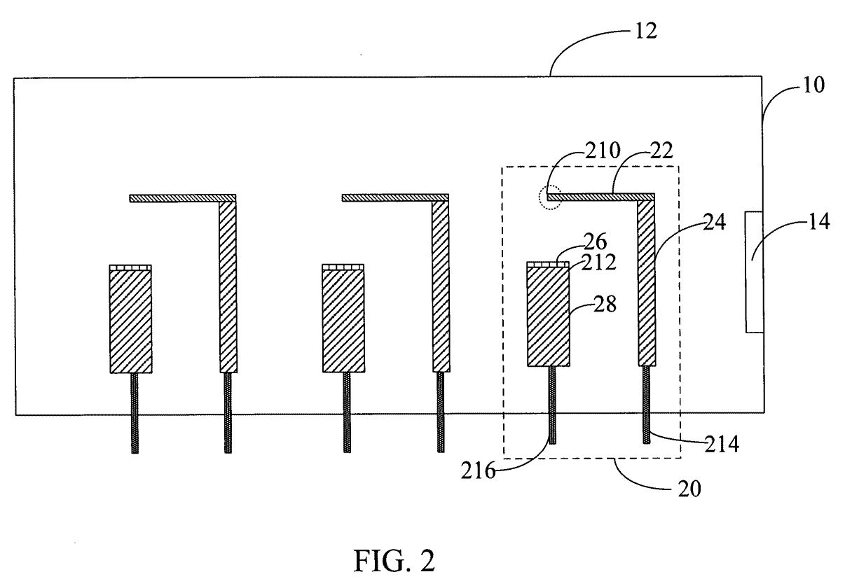

In each color element 20, the anodes, the phosphor layers and the CNT strings have the same structures, and thus the cathode 24, the anode 28, the phosphor layer 26 and the CNT string 22 are described in the following as an example. Referring to FIG. 2, the phosphor layer 26 with a thickness of about 5-50 microns (μm) is formed on the end surface 212 of the anode 28. The phosphor layer 26 may be a white phosphor layer, or a color phosphor layer, such as red, green or blue. The end surface 212 is a polished metal surface or a plated metal surface, and thus can reflect the light beams emitted from the phosphor layer 26 to the permeable portion 12 to enhance the brightness of the color FED 100.

The CNT string 22 is electrically connected to and in contact with the cathode 24 by a conductive paste, such as silver paste, with an emission portion 210 of the CNT string 22 suspending. The phosphor layer 26 is opposite to the light permeable portion 12, and the emission portion 210 is corresponding to the phosphor layer 26. A distance between the emission portion 210 and the phosphor layer 26 is less than 5 mm. The emission portion 210 can be arranged perpendicular to the phosphor layer 26, parallel to phosphor layer 26 or inclined to phosphor layer 26 with a certain angle. In the present embodiment, the emission portion 210 is parallel to phosphor layer 26, and arranged between the phosphor layer 26 and the light permeable portion 12. The cathode 24 is made of an electrically conductive material, such as nickel, copper, tungsten, gold, molybdenum or platinum.

The CNT string 22 is composed of a number of closely packed CNT bundles, and each of the CNT bundles includes a number of CNTs, which are substantially parallel to each other and are joined by van der Waals attractive force. A diameter of the CNT string 22 is in an approximate range from 1 to 100 microns (μm), and a length thereof is in an approximate range from 0.1-10 centimeters (cm).

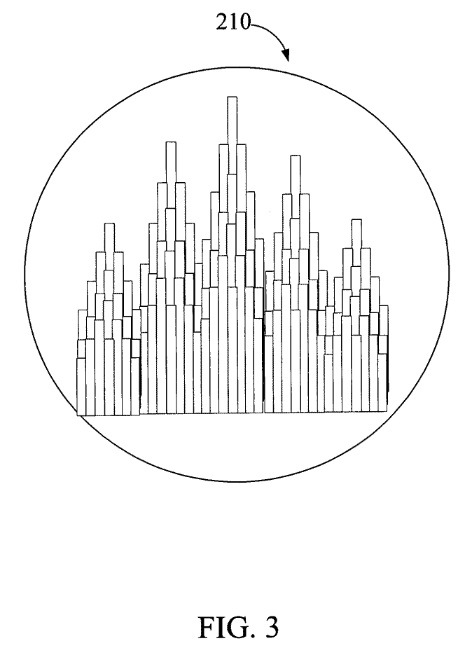

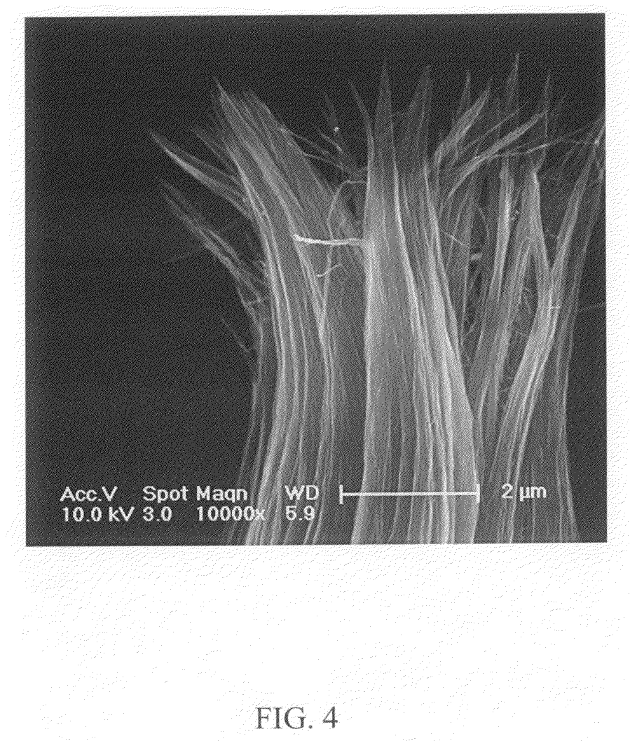

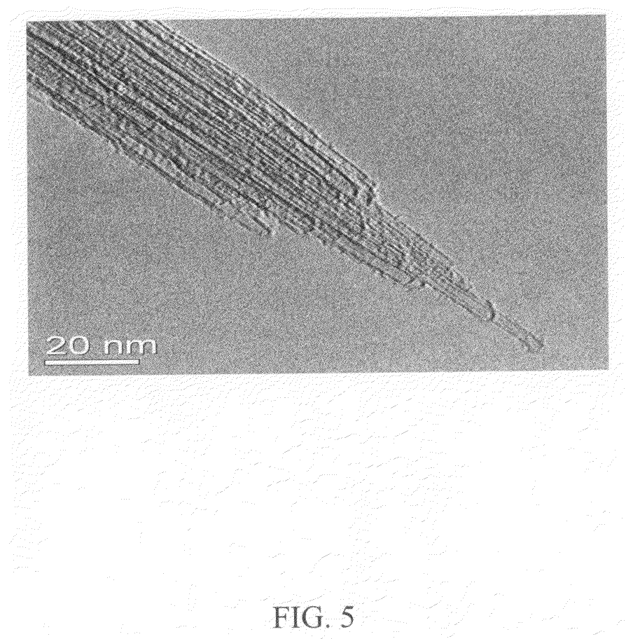

Referring to FIGS. 3, 4 and 5, the CNTs at the emission portion 210 form a tooth-shaped structure, i.e., some of CNT bundles being taller than and projecting above the adjacent CNT bundles. Therefore, a shield effect caused by the adjacent CNTs can be reduced. The voltage applied to the CNT string 22 for emitting electrons is reduced. The CNTs at the emission portion 210 have smaller diameter and fewer number of graphite layer, typically, less than 5 nanometer (nm) in diameter and about 2-3 in wall. However, the CNTs in the CNT string 22 other than the emission portion 210 are about 15 nm in diameter and more than 5 in wall.

A method for making the CNT string 22 is taught in U.S. Application No. US16663 entitled “METHOD FOR MANUFACTURING FIELD EMISSION ELECTRON SOURCE HAVING CARBON NANOTUBES”, which is incorporated herein by reference. The CNT string 22 can be drawing a bundle of CNTs from a super-aligned CNT array to be held together by van der Waals force interactions. Then, the CNT string 22 is soaked in an ethanol solvent, and thermally treated by supplying a current thereto. After the above processes, the CNT string 22 has improved electrical conducting and mechanical strength.

In operation, a voltage is applied between the cathode 24 and the anode 28 through the cathode terminal 216 and the anode terminal 214, an electric field is formed therebetween, and electrons are emanated from the emission portion 210 of the CNT string 22. The electrons transmit toward the anode 28, hit the phosphor layer 26, and the visible light beams are emitted from the phosphor layer 26. One part of the light beams transmits through the light permeable portion 12, another part is reflected by the end surface 212 and then transmits out of the light permeable portion 12. Using the CNT string 22, the luminance of the color FED 100 is enhanced at a relatively low voltage.

The color FED 100 may further includes a getter 14 configured for absorbing residual gas inside the sealed container 10 and maintaining the vacuum in the inner space of the sealed container 10. More preferably, the getter 14 is arranged on an inner surface of the sealed container 10. The getter 14 may be an evaporable getter introduced using high frequency heating. The getter 14 also can be a non-evaporable getter.

The color FED 100 may further includes an air vent (not shown). The air vent can be connected with a gas removal system such as, for example, a vacuum pump for creating a vacuum inside the sealed container. The color FED 100 is evacuated to obtain the vacuum by the gas removal system through the air vent, and then sealed.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A color field emission display comprising:
a sealed container having a light permeable portion;
at least one color element enclosed in the sealed container, the color element comprising:
a cathode;
at least two anodes;
at least two phosphor layers, each phosphor layer formed on an end surface of the corresponding anode, the phosphor layers opposite to the light permeable portion;
at least two CNT strings electrically connected to and in contact with the cathode with each emission portion of the CNT strings suspending, each emission portion corresponding to one phosphor layer, wherein in each CNT string, some of CNT bundles being taller than and projecting over the adjacent CNT bundles, and each of projecting CNT bundles functioning as an electron emitter.

2. The color field emission display as claimed in claim 1, wherein the emission portions of CNT strings are arranged between the corresponding phosphor layer and the light permeable portion.

3. The color field emission display as claimed in claim 1, wherein a diameter of the CNT string is in an approximate range from 1 to 100 microns, and a length of the CNT string is in an approximate range from 0.1-10 centimeters.

4. The color field emission display as claimed in claim 1, wherein the CNT string is composed of a plurality of closely packed CNT bundles, each of the CNT bundles comprises a plurality of CNTs, the CNTs are substantially parallel to each other and are joined by van der Waals attractive force.

5. The color field emission display as claimed in claim 4, wherein the CNTs at the emission portion have a diameter of less than 5 nanometers and a number of graphite layer of about 2-3.

6. The color FED as claimed in claim 4, wherein the CNTs in the CNT string other than the emission portion have a diameter of about 15 nanometers and a number of graphite layer of more than 5.

7. The color field emission display as claimed in claim 1, further comprising at least two anode terminals and a cathode terminal, wherein the anode terminals are electrically connected to the corresponding anodes, and the cathode terminal is electrically connected to the cathode.

8. The color field emission display as claimed in claim 7, wherein the anode terminals and the cathode terminal run from the inside to the outside of the sealed container.

9. The color field emission display as claimed in claim 1, wherein the cathode, the anodes, the cathode terminal and the anode terminals are made of thermally and electrically conductive materials.

10. The color field emission display as claimed in claim 9, wherein the anodes are made of metal materials, and the end surfaces of the anodes are polished metal surfaces or plated metal surfaces.

11. The color field emission display as claimed in claim 1, wherein the sealed container is a hollow member that defines an inner space in vacuum.

12. The color field emission display as claimed in claim 1, wherein the sealed container is comprised of quartz or glass.

13. The color field emission display as claimed in claim 1, wherein a diameter of the sealed container is about 1-5 millimeters, and a height of the sealed container is about 2-5 millimeters.

14. The color field emission display as claimed in claim 1, wherein the light permeable portion has a surface selected from the group consisting of a plane surface, a spherical surface and an aspherical surface.

15. The color field emission display as claimed in claim 1, wherein the CNT strings are electrically connected to and in contact with the cathode by conductive paste.

16. The color field emission display as claimed in claim 1, wherein the emission portions of the CNT strings are suspending.

17. The color field emission display as claimed in claim 1, wherein a distance between the emission portion of the CNT string and the corresponding phosphor layer is less than 5 millimeters.

18. The color field emission display as claimed in claim 1, wherein the emission portions are arranged perpendicular to the phosphor layers, parallel to phosphor layers or inclined to phosphor layers with a certain angle.

19. The color field emission display as claimed in claim 1, further comprising a getter, wherein the getter is arranged on an inner surface of the sealed container.

20. The color field emission display as claimed in claim 1, wherein the distances between the cathode and the anodes are about 10-200 μm, and the spaces among the anodes are substantially equal.
